(19) United States
(12) Patent Application Publication
(10) Pub. No.: US 2002/0149264 A1
(43) Pub. Date: Oct. 17, 2002

(54) Method and apparatus for retaining programming in a volatile memory unit

(76) Inventors: Jonathan C. Baiardo, Fort Collins, CO (US); Kelly J. Reasoner, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/834,248

(22) Filed: Apr. 11, 2001

(51) Int. Cl. H02J 9/00

(52) U.S. Cl. 307/66

(57) ABSTRACT

A small portable power supply is connected to a circuit board comprising a volatile memory unit. The main circuit board power supply is then disconnected from the circuit board, and the board may now be physically moved to another location without the loss of the data contained within the volatile memory. At the new location, another main circuit board power supply may be connected to the circuit board, and the small portable power supply may be disconnected, completing the transfer of the circuit board without any loss of data.

### FIELD OF THE INVENTION

The present invention relates generally to the field of electronic circuits, and more particularly to the field of retaining programming in volatile memory elements of an electronic circuit during transportation.

### BACKGROUND OF THE INVENTION

Volatile memory units such as random access memories (RAMs) and field programmable gate arrays (FPGAs) have long been used in the design of electronic devices. They allow the designer to locally store data and instructions, and to quickly and easily change the custom programming of a gate array device. Often a designer will program the FPGA or load the RAM on a design station and later will need to take the circuit board including the FPGA and/or RAM to an emulator station where the full circuit will undergo testing. It may even sometimes be necessary to ship the circuit board to a remote site for diagnosis or evaluation. Normally this involves disconnecting the circuit board from a power supply and physically moving the board to the emulator station. Once the power supply is disconnected, the FPGA and RAM lose their programming and the designer must reprogram the FPGA and re-load the RAM data on the emulator station. This requires the designer to transport the FPGA programming data and memory data from the design station to the emulator station either through removable storage media or across a network connection. This process of transporting this data is open to several possibilities for errors or difficulties to enter the process. For example, the designer may accidentally copy the wrong version of the data to the removable storage media, then spend a great amount of time finding this problem once the incorrect data is used to program the FPGA or load the memory unit on the emulator station. Also, transfer of the data either through the network or removable storage media increases the possibility of incomplete transfers or other errors. These errors also may take a great amount of time to discover on the emulator station. Thus, there is a need in the art for an apparatus and method for transporting volatile memory units while retaining their contents.

### SUMMARY OF THE INVENTION

A small portable power supply is connected to a circuit board comprising a volatile memory unit. The main circuit board power supply is then disconnected from the circuit board, and the board may now be physically moved to another location without the loss of the data contained within the volatile memory. At the new location, another main circuit board power supply may be connected to the circuit board, and the small portable power supply may be disconnected, completing the transfer of the circuit board without any loss of data.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic diagram of a device for use in transporting circuit boards without losing the programming data of any attached volatile memory units.

FIG. 2 is a flowchart of a method for transporting circuit boards without losing the programming data of any attached volatile memory units.

### DETAILED DESCRIPTION

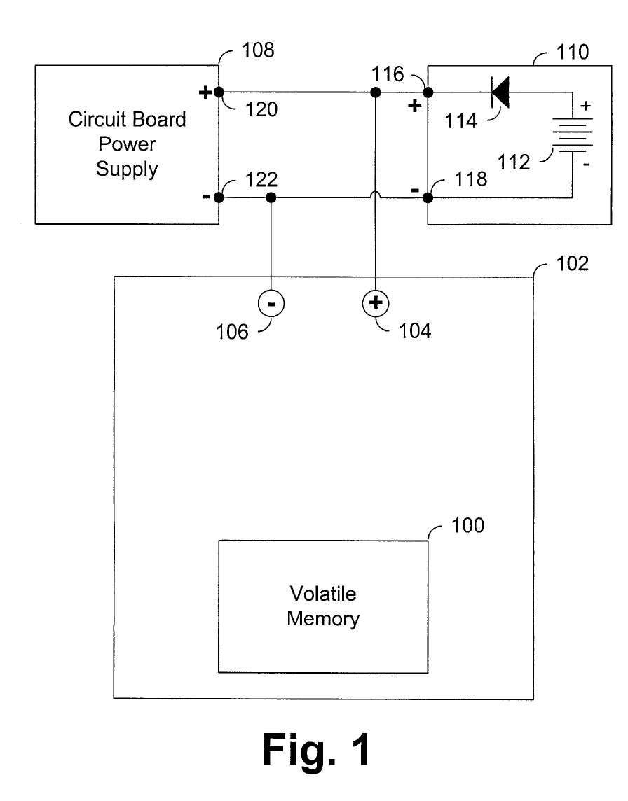

FIG. 1 is a schematic diagram of a device for use in transporting circuit boards without losing the programming data of any attached volatile memory units. One or more volatile memory unit 100 is included within the circuitry on a circuit board 102. A positive power supply connection node 104 and a negative power supply connection node 106 are included on the circuit board. During normal operation the circuit board 102 is powered by a circuit board power supply 108. This circuit board power supply 108 has at least two outputs, a positive power supply output 120, and a negative power supply output 122. The positive power supply output 120 is normally connected to the positive power supply connection node 104 and the negative power supply output 122 is normally connected to the negative power supply connection node 106. The positive power supply connection node 104 and the negative power supply connection node 106 in an example embodiment of the present invention are non-permanent connections such that the circuit board power supply 108 may be easily connected and disconnected. In other embodiments of the present invention the positive power supply connection node 104 and the negative power supply connection node 106 may be physically coupled in a single connector that includes both positive and negative connection nodes. A portable power supply 110 may be connected in parallel with the circuit board power supply 108. In an example embodiment of the present invention, the portable power supply 110 comprises a battery 112 and a diode 114 connected in series. The diode 114 protects the battery 112 from a reverse voltage created when the circuit board power supply 108 is connected at the same time as the portable power supply 110. This diode 114 is optional in some embodiments of the present invention. The negative node of the battery 112 is electrically connected to the negative output 118 of the portable power supply 110 and the positive node of the battery 112 is connected to the anode of the diode 114. The cathode of the diode 114 is connected to the positive output 116 of the portable power supply 110. The negative output 118 of the portable power supply 110 is configured to allow connection to the negative power supply connection node 106 and the positive output 116 of the portable power supply 110 is configured to allow connection to the positive power supply connection node 104.

In an example embodiment of the present invention the battery 112 is a 9-volt battery. In this embodiment, the circuit board may include a voltage converter capable of stepping down the output of the 9-volt battery to a level usable by the electronic devices such as 5 volts or 3.3 volts. Many such converters are capable of receiving a wide range of input voltages. This allows the use of different voltages in the circuit board power supply 108 and the portable power supply 110. Note that if different voltages are used, input protection must be present to avoid damage to the supplies. In another embodiment of the present invention, the battery 112 is a rechargeable battery that is configured such that it automatically recharges when the portable power supply 110 is connected in parallel with the circuit board power supply 108.

Note that if the volatile memory unit comprises dynamic RAM (DRAM), in addition to providing power to the DRAM, the portable power supply must also supply power to the peripheral circuitry required by the DRAM to refresh its array, or the contents of the DRAM will be lost.

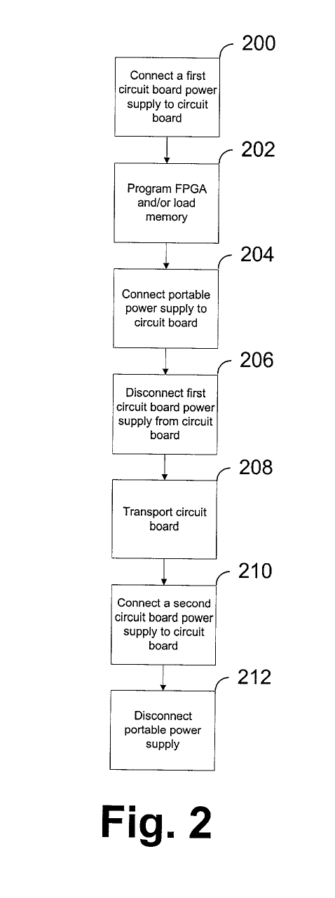

FIG. 2 is a flowchart of a method for transporting circuit boards without losing the programming data of any attached volatile memory units. In a step 200, a circuit board power supply 108 is electrically connected to a circuit board 102 containing at least one volatile memory unit 100. In a step 202, this one or more volatile memory unit 100 is programmed by the user. This volatile memory unit may be a FPGA, static RAM (SRAM), dynamic RAM (DRAM), or any other volatile memory in any combination. In a step 204, a portable power supply 110 is connected to the circuit board 102 in parallel with the circuit board power supply 108. In a step 206, the circuit board power supply 110 is disconnected, leaving the portable power supply 110 powering the circuit board 102. In a step 208, the circuit board 102 and portable power supply 110 are transported to a different location. Note that this different location is not limited in scope to a building, city, state or country. The different location may be anywhere reachable within the time available given the amount of charge in the battery. In a step 210, a circuit board power supply 110 at the new location is connected to the circuit board 102 in parallel with the portable power supply 110. Note that this circuit board power supply 110 is likely to be an equivalent but different supply than that used to power the circuit board 102 during programming. In a step 212, the portable power supply 110 is disconnected from the circuit board 102, leaving it powered by the circuit board power supply 108. Alternately, in an example embodiment of the present invention, the portable power supply 110 may remain connected in parallel with the circuit board power supply 108 for recharging of the battery 112 within the portable power supply 110. Alternately, in another example embodiment of the present invention, there may be no need to connect the circuit board power supply 108 at all at the new location. For example, if the board is being moved for a short period of time for testing, it may be possible to leave the board powered by the portable power supply 110 during testing. After testing, the board can be moved back to the original location and reattached to the original circuit board power supply 108. Note that in some implementations of the present invention, the portable power supply 110 may be incorporated into the circuit board 102 such that it is an integral part of the circuit board 102. This would allow a manufacturer to ship a complex electronic product, such as a computer server, to a customer including a board with a portable power supply 110 incorporated into the board 102. Then, if fatal errors were encountered in the field, the manufacturer could have the customer, or their service technicians, swap boards and ship the error prone board back to the manufacturer for failure analysis. The circuit board 102 incorporating the portable power supply 110 would retain all of the information in the volatile memory devices included on the circuit board 102. In another example embodiment of the present invention similar to the previous example, a manufacturer would ship a portable power supply 110 to a customer with instructions on connecting the portable power supply 110 to a problematic circuit board before powering down the equipment. The customer could then mail the circuit board and supply to the manufacturer for failure analysis facilitated by the information present in the volatile memory units.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A portable electronic device for maintaining programming within a volatile memory unit during transportation comprising:
a battery; and
a non-permanent contact including a positive node and a negative node configured to be electrically coupled to a device including at least one volatile memory unit, wherein said non-permanent contact positive node is electrically coupled with a positive node of said battery, and said non-permanent contact negative node is electrically coupled with a negative node of said battery.

2. A portable electronic device for maintaining programming within a volatile memory unit during transportation as recited in claim 1, further comprising:
a diode, electrically connected in series between said positive node of said battery and said non-permanent contact positive node, wherein an anode of said diode is electrically coupled with a positive node of said battery.

3. A portable electronic device for maintaining programming within a volatile memory unit during transportation as recited in claim 2;
wherein said battery is a 9-volt battery.

4. A portable electronic device for maintaining programming within a volatile memory unit during transportation as recited in claim 2;
wherein said non-permanent contact negative and positive nodes are configured such that a circuit board power supply may be connected in parallel with said portable electronic device.

5. A portable electronic device for maintaining programming within a volatile memory unit during transportation as recited in claim 4;
wherein said battery is rechargeable, and is configured to recharge while connected in parallel with said circuit board power supply.

6. A portable electronic device for maintaining programming within a volatile memory unit during transportation as recited in claim 1;
wherein said non-permanent contact includes signal lines.

7. A portable electronic device for maintaining programming within a volatile memory unit during transportation comprising:
a battery;
a positive non-permanent contact electrically coupled with a positive node of said battery; and
a negative non-permanent contact electrically coupled with a negative node of said battery, wherein said positive and negative contacts are electrically coupled with a device including at least one volatile memory unit.

8. A portable electronic device for maintaining programming within a volatile memory unit during transportation as recited in claim 7, further comprising:
a diode, electrically connected in series between said positive node of said battery and said positive non-permanent contact, wherein an anode of said diode is electrically coupled with a positive node of said battery.

9. A portable electronic device for maintaining programming within a volatile memory unit during transportation as recited in claim 8;
wherein said battery is a 9-volt battery.

10. A portable electronic device for maintaining programming within a volatile memory unit during transportation as recited in claim 8;
wherein said negative and positive non-permanent contacts are configured such that a circuit board power supply may be connected in parallel with said portable electronic device.

11. A portable electronic device for maintaining programming within a volatile memory unit during transportation as recited in claim 10;
wherein said battery is rechargeable, and is configured to recharge while connected in parallel with said circuit board power supply.

12. A portable electronic device for maintaining programming within a volatile memory unit during transportation as recited in claim 8;
wherein said positive and negative non-permanent contacts are mechanically coupled.

13. A portable electronic device for maintaining programming within a volatile memory unit during transportation comprising:
a battery;
means for non-permanently electrically coupling a positive node of said battery with a positive node of a device including at least one volatile memory unit; and
means for non-permanently electrically coupling a negative node of said battery with a negative node of said device including at least one volatile memory unit.

14. A portable electronic device for maintaining programming within a volatile memory unit during transportation as recited in claim 13, further comprising:
a diode, electrically connected in series between said positive node of said battery and said means for non-permanently electrically coupling a positive node of said battery, wherein an anode of said diode is electrically coupled with a positive node of said battery.

15. A portable electronic device for maintaining programming within a volatile memory unit during transportation as recited in claim 13;
wherein said battery is a 9-volt battery.

16. A portable electronic device for maintaining programming within a volatile memory unit during transportation as recited in claim 13;
wherein said means for non-permanently electrically connecting said negative and positive nodes of said battery are configured such that a circuit board power supply may be connected in parallel with said portable electronic device.

17. A portable electronic device for maintaining programming within a volatile memory unit during transportation as recited in claim 16;
wherein said battery is rechargeable, and is configured to recharge while connected in parallel with said circuit board power supply.

18. A portable electronic device for maintaining programming within a volatile memory unit during transportation as recited in claim 13;
wherein said means for electrically connecting said positive and negative nodes of said battery are mechanically coupled.

19. A method for maintaining programming within a volatile memory unit during transportation comprising the steps of:
a) connecting a portable power supply to a circuit board including at least one programmed volatile memory unit;
b) disconnecting a first circuit board power supply from said circuit board; and
c) transporting said circuit board and connected portable power supply to a location;

20. A method for maintaining programming within a volatile memory unit during transportation as recited in claim 19, further comprising the step of:
d) connecting a second circuit board power supply to said circuit board.

21. A method for maintaining programming within a volatile memory unit during transportation as recited in claim 20, further comprising the step of:
e) disconnecting said portable power supply from said circuit board.

22. A method for maintaining programming within a volatile memory unit during transportation as recited in claim 19;
wherein said portable power supply includes a battery.

23. A method for maintaining programming within a volatile memory unit during transportation as recited in claim 22;
wherein said battery is rechargeable, and is configures to recharge while connected in parallel with a circuit board power supply.

24. A method for maintaining programming within a volatile memory unit during transportation as recited in claim 22;
wherein said battery is a 9-volt battery.

25. A method for maintaining programming within a volatile memory unit during transportation as recited in claim 22;
wherein said battery is diode protected from a reverse voltage created when a circuit board power supply is connected for a same time as said portable power supply.
